(19) United States
(12) Patent Application Publication
(10) Pub. No.: US 2024/0050864 A1
(43) Pub. Date: Feb. 15, 2024

(54) INTELLIGENT PHONE CASE APPARATUS AND METHODS

(71) Applicant: Dean Schumacher, Orchard Lake, MI (US)

(72) Inventor: Dean Schumacher, Orchard Lake, MI (US)

(21) Appl. No.: 18/238,220

(22) Filed: Aug. 25, 2023

Related U.S. Application Data
(63) Continuation-in-part of application No. 17/859,867, filed on Jul. 7, 2022.
(60) Provisional application No. 63/218,968, filed on Jul. 7, 2021.
(60) Provisional application No. 63/314,863, filed on Feb. 28, 2022.

(51) Int. Cl. A63F 13/98; A63F 13/92; A63F 13/285

(52) U.S. Cl. CPC A63F 13/98; A63F 13/92; A63F 13/285

(57) ABSTRACT

An accessory for a mobile computing device includes a body defining an interior configured to secure a mobile computing device, an accessory mechanism coupled to the body and configured to perform at least one supporting action for the mobile computing device, and a communications module configured to receive an electronic command to engage the accessory mechanism.

### CROSS-REFERENCE TO RELATED APPLICATIONS

This application is a Continuation-in-Part of U.S. patent application Ser. No. 17/859,867 entitled “INTELLIGENT PHONE CASE APPARATUS AND METHODS,” filed Jul. 7, 2022, which is a non-provisional conversion of U.S. Pat. App. No. 63/218,968 entitled “INTELLIGENT PHONE CASE APPARATUS AND METHODS,” filed Jul. 7, 2021, and of U.S. Pat. App. No. 63/314,863 entitled “INTELLIGENT PHONE CASE APPARATUS AND METHODS,” filed Feb. 28, 2022, the contents of which are incorporated herein in their entireties and for all purposes.

### TECHNICAL FIELD

This disclosure generally relates to an intelligent case for a mobile device, and methods of use of the apparatus.

### BRIEF DESCRIPTION OF THE DRAWINGS

FIG. 1 is a block diagram view of an example intelligent phone case that can execute a mobile electronic device accessory projectile propulsion activity.

FIG. 2 is a flow chart illustrating an example method of using the intelligent phone case to perform a mobile electronic device projectile propulsion activity.

FIG. 3 is a flow chart illustrating an example method of using the intelligent phone case to perform a mobile electronic device projectile propulsion activity.

FIG. 4 is a flow chart illustrating an example method of using the intelligent phone case to perform a mobile electronic device projectile propulsion activity.

FIG. 5 is a diagrammatic view of an example embodiment of a user computing environment.

FIG. 6 is a flow chart illustrating an example method of coordinating mobile device activities using accessories.

### DETAILED DESCRIPTION

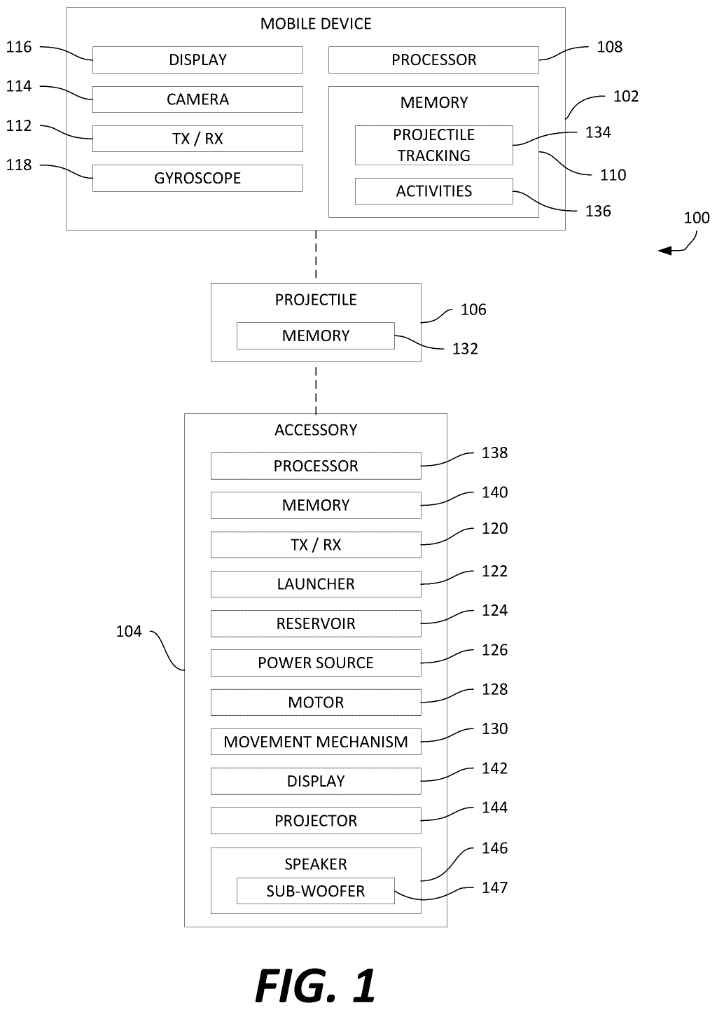

Referring to the drawings, wherein like reference numerals refer to the same or similar features in the various views, FIG. 1 is a block diagram view of an example system 100 including an intelligent phone case that can execute a mobile electronic device accessory projectile propulsion activity, among many other activities and functions. The system 100 may include a mobile computing device 102 (which may be referred to herein simply as a mobile device), an accessory 104, and one or more projectiles 106. The mobile computing device 102 may be or may include a mobile phone, tablet, etc. The mobile computing device 102 may include a processor 108 and a non-transitory, computer-readable memory 110. The memory 110 may store instructions that, when executed by the processor 108, cause the processor 108 to perform one or more steps, processes, methods, etc. of this disclosure. The mobile computing device 102 may further include a communications module 112 (labeled as “Tx/Rx” in FIG. 1), an imaging device, such as a camera 114, a display 116, and a gyroscope 118. The communications module 112 may transmit and/or receive data over any appropriate communications channel, such as WiFi, Bluetooth, NFC, RF, GSM, CDMA, etc. The communications module 112 may be further configured to scan a memory of the projectile 106, such as an RFID chip, NFC-enabled memory, etc.

The camera 114 may be configured to capture one or more images, including sequential images in the form of video. The display 116 may be an integrated display, or may be a separate display in communication with the mobile device 102.

The accessory 104 (may be alternatively referred to as “intelligent phone case”) may be removably attachable to the mobile device 102, in some embodiments. For example, the accessory 104 may take the form of a case for the mobile device, in some embodiments. Accordingly, the accessory 104 may include a body defined by a back wall and a plurality of sidewalls collectively defining an interior configured to secure the mobile device 102, in some embodiments. The accessory back wall may define one or more apertures, such as one or more apertures for light to pass to one or more camera lenses or for extension of a camera bump or similar structure through the case back wall, for example. The accessory back wall or sidewalls may include additional apertures for user access to one or more ports of the mobile device, such as USB ports, or for user access to one or more buttons on the mobile device 102. The accessory 104 may further be uniquely associated to a particular user and a particular device such that the accessory 104 provides or functions as a token (e.g., via communications module 120 or other communicative link) that authorizes the mobile device 102 to perform a set of actions when the accessory 104 detects that the mobile device 102 is coupled to the accessory 104. The accessory 104 may disable one or more of the set of actions upon disconnection or detachment from the mobile device 102. In one example, the set of actions may include a single sign on authentication to a plurality of apps when the mobile device 102 is coupled to the accessory 104, which sign on is disabled when the accessory 104 and mobile device 102 are not coupled together.

The accessory 104 may include a communications module 120 (labeled as “Tx/Rx” in FIG. 1), a projectile launcher 122, a projectile reservoir 124, a power source 126, a motor 128, movement mechanism 130, a processor 138, a memory 140, a display 142, and a projector 144, each of which may be coupled to (e.g., contained within) the body of the accessory 104.

The communications module 120 may transmit and/or receive data over any appropriate communications channel, such as WiFi, Bluetooth, NFC, RF, GSM, CDMA, etc., and may be configured for communications with the communications module 112 of the mobile device 102.

The projectile reservoir 124 may hold one or more projectiles 106, which projectiles 106 may be ejected from the accessory 104 by the launcher 122. Accordingly, the reservoir 124 may be configured to receive projectiles 106 inserted by a user and to dispense one or more projectiles 126 to the launcher 122. The launcher 122 may include one or more mechanisms for ejecting a projectile 106 from the accessory 104. For example, the launcher 122 may include an arm or plunger coupled to a spring, for example. The launcher 122 may eject a projectile 106 in response to user actuation of a trigger or switch on the accessory 104, or responsive to an electronic command received through the communications module 120. Upon ejection of a projectile 106, the accessory 104 may transmit information about the projectile ejection to the mobile device 102, such as an identifier of the projectile, an ejection timestamp, or other information that may assist the mobile device 102 in tracking the projectile 106 or determining the appropriate decision to be made based on the accuracy or outcome of the projectile 106.

Each projectile 106 may be or may include a disk, sphere, block, dart, or other physical projectile (as distinguished from water or light). In some embodiments, a projectile 106 may include a non-transitory, computer-readable memory 132. The memory 132 of the projectile 106 may include information that may be used in one or more activities involving the projectile 106. The memory 132 may take the form of a readable tag, in some embodiments. For example, the memory may include an RFID tag or an NFC-readable chip.

In an embodiment, the reservoir 124 may hold, and the launcher 122 may eject, multiple projectiles 106 that are identical in size and shape. In an embodiment, the reservoir 124 may hold, and the launcher 122 may eject, multiple projectiles 106 that are different from each other in size or shape. The launcher 122 may be manually powered and mechanically actuated, such as by user retraction and mechanical actuation for release, in some embodiments. In other embodiments, the launcher may be electrically powered and may draw power from the power source 126, which may be a battery, in some embodiments.

The movement mechanism 130 may be provided to enable movement of the accessory 104, either when attached to or detached from the mobile device 102. In some embodiments, the movement mechanism 130 may be coupled to the motor 128 to drive the movement mechanism 130, and thereby effect movement of the accessory 104. Instead of or in addition to the movement mechanism 130, the accessory 104 may include one or more vibration elements for movement. The motor 128 may be electrically coupled to the power source 126.

The movement mechanism 130 may include one or more wheels in mechanical communication with the motor 128, such that the motor 128 may cause the wheels to rotate. The movement mechanism 130 may include a tread that includes one or more gears and a band about the gears. The gears may be in mechanical communication with the motor 128, such that the motor 128 may cause the gears to rotate, thereby moving the band. The movement mechanism 130 may include a propeller or similar mid-air propulsion device in mechanical communication with the motor.

The power source 126 may include a battery, in some embodiments. Additionally or alternatively, the power source 126 may include a USB or wireless power connection with the mobile device 102 to draw power from the battery of the mobile device 102.

The launcher 122, reservoir 124, and motor 128 may respond to commands received through the communications module 120 of the accessory 104. For example, the launcher 122 may eject one or more projectiles 106 responsive to commands received through the communications module 120, the reservoir 124 may pass one or more projectiles to the launcher 122 in response to commands received through the communications module 120, and/or the motor 128 may actuate the movement mechanism 130 (or vibration element, or other movement element) in response to commands received through the communications module 120. In some embodiments, the communications module 120 may include an RFID or other wireless short range data writer to revise data stored on projectiles 106 before they are ejected, or to read information respective of a projectile as it is ejected.

The memory 140 may store instructions that, when executed by the processor 138, cause the processor 138 to perform one or more steps, processes, methods, etc. of this disclosure. In some embodiments, the mobile device 102 may utilize the processor 138 for one or more processing tasks. Accordingly, the mobile device 102 may communicate with the accessory 104 to request or instruct the accessory 104 to perform one or more of the steps, processes, methods, etc. of this disclosure. Similarly, the accessory 104 may communicate with the mobile device 102 to request or instruct the mobile device 102 to perform one or more of the steps, processes, methods, etc. of this disclosure. Similarly, the mobile device 102 and accessory 104 may use the memory 110, 140 of the other for the storage of data.

The display 142 may perform, or may be used to perform, one or more of the functions of the mobile device display 116 described herein. Accordingly, the display 142 may be used to display information, input, or output respective of one or more of the functions of the accessory 104. In some embodiments, the mobile device 102 and accessory 104 may coordinate their respective displays 116, 142 to display one or more user interfaces, videos, etc. For example, the displays 116, 142 may display identical output. In another example, the display 116 may output a first user interface portion, and the display 142 may output a second user interface portion that is different from, but related to (e.g., a subset of, overlapping with, etc.), the first user interface portion. In another example, a virtual keyboard may be provided on the display 142 for user input, independent of or relative to information displayed on the display 116. One or both of the displays 116, 142 may thus be a touchscreen. Additionally or alternatively, the accessory 104 may include a physical keyboard for similar input.

The projector 144 may include one or more illumination sources, lenses, lasers, etc. for projecting an image, video, or light field. The projected images or video from the projector 144 may serve as a target for a projectile-based activity, such as a projectile-based activity described herein. For example, the projector 144 may project an image, video, or light field, and a camera of another accessory 104 may capture video of a projectile passing through the image, video, or light field, and that video may be analyzed to determine an accuracy of the projectile. In another example, the projector may project a laser light field from a projector to a receiver, and the accessory 104 may determine an accuracy of a projectile according to whether or not, and when, one or more portions of the light field are broken.

In some embodiments, the accessory 104 may output light from the projector 144 in conjunction with one or more other accessories 104 (e.g., accessories paired with other mobile devices 102). For example, two accessories 104 may output the same projected image (e.g., a target having the same shape and/or scores). In another example, multiple accessories may output an image in a video arrangement having more than two channels (e.g., one channel per projector 144), such that the projected images may be overlaid to form a new image. In another example, a group of multiple mobile devices 102 and accessories 104 may be involved in a common game or other activity, and one of the accessories or mobile phones may project a single image to be used for the game with the multiple mobile devices 102 and accessories 104. Accordingly, all of the projectors 144 in the group may project an image onto the shared single image (e.g., pieces on a game board).

In another example, each accessory 104 may project, via the projector 144, a screen or display for a game or app being played on the mobile device 102 coupled to the accessory 104. An accessory 104 may be used without other accessories 104 to, for example, play a single-player game in order to display that game on a wall rather than view the game on the mobile device 102. That said, the accessory 104 may be used with other accessories 104 to communicate data about a multiplayer game (e.g., a racing game, a combat simulator, etc.) and display a coordinated image or screen based on the shared multiplayer game. For example, if the multiplayer game is a racing game, the accessories 104 may communicate to project an image of the racetrack with continuously-updating positions based on the position of each player on their own mobile device 102.

The speaker 146 may include one or more speakers and may serve several functions independent of and/or in conjunction with the mobile device 102. For example, the speaker 146 may serve as an external speaker for the mobile device 102, or may independently play music or other sound output by the accessory 104, separate from output of the mobile device 102. In some embodiments, the speaker 146 may include a sub-woofer 147 or similar output component focused on sounds in the bass range in order to address the long-felt but unmet need of internal mobile device 102 speakers lacking bass.

In some embodiments, the accessory 104 may output sound through the speaker 146 in conjunction with one or more other accessories 104 (e.g., accessories paired with other mobile devices 102). For example, two accessories 104 may output multi-channel sound, such as a stereo pair. In another example, multiple accessories may output sound in a sound arrangement having more than two channels (e.g., one channel per speaker). In another example, a group of multiple mobile devices 102 and accessories 104 may be involved in a common game or other activity, and one of the accessories or mobile phones may hold sound control over the multiple mobile devices 102 and accessories 104. Accordingly, all of the speakers 146 in the group may output a song or other audible output chosen by the user of the controlling accessory 104. Control may result from, for example, a winning score or successful action in a game played by the group. Accordingly, multiple accessories 104 may communicate with each other for the exchange of data and instructions, in some embodiments.

In some embodiments, the accessory 104 may output sound through the speaker 146 in combination and in coordination with light from the projector 144. For example, the accessory 104 may command the speaker 146 to output a sound and the projector 144 to output a pattern of light simultaneously. The sound and the pattern of light may be synchronized, such that the sound may match, align with, share a rhythm, or otherwise go with the pattern of light. In one example, the accessory 104 may command the simultaneous sound and pattern of light in response to a user's success (or failure) with the accessory. In another example in which the sound from the speaker 146 is a song, the accessory 104 may command a pattern of light that simulates a light show for the song, or a projection of a music video accompanying the song.

The mobile device memory 110 may include a projectile tracking module 134. The projectile tracking module 134 may include functionality for receiving images from the camera 114 and analyzing the images for determining the flight path and/or location of a projectile 106 fired from the accessory 104. For example, the projectile tracking module 134 may perform object recognition to identify a projectile 106 and its position relative to the camera 114, relative to one or more other objects, relative to a background, etc. and may compare two or more images to each other to identify movement of the projectile 106. In some embodiments, the projectile tracking module 134 may be configured to determine the location of another instance of the accessory 104 (e.g., an accessory 104 on or associated with a second mobile device 102) and/or the location of another mobile device 102, and to determine the position of a projectile 106 relative to the other accessory 104 or mobile device 102.

The mobile device memory 110 may further include an activities module 136. The activities module 136 may include functionality for performing one or more games or other activities with system 100, including one or more of: providing an electronic user interface on the display 116 of the mobile device 102 through which the user may provide one or more commands for controlling the accessory 104; causing commands to be transmitted to the accessory 104 to control the launcher 122 for ejection of one or more projectiles 106, to control movement of the accessory 104, and/or to cause the accessory 104 to perform some other function; determining an outcome of the flight of one or more projectiles 106 (e.g., in conjunction with the projectile tracking module 134); outputting an outcome of the flight of one or more projectiles 106 to the user; and/or outputting instructions to a user for participating in one or more activities.

The activity module 136 may further accept input from a user of data to be stored on or encoded in the memory 132 of a projectile 106, and transmit that data to the projectile 106 for storage in the memory 132.

In some embodiments, the projectile tracking module 134 and activities module 136 may be collectively embodied in an application that may be installed to the mobile computing device 102. In some embodiments, the accessory 104 may include or may be packaged with (e.g., when sold or distributed) a QR code or bar code that, when scanned by a mobile device 102, enables the user of the mobile device 102 to download the application on the mobile device 102.

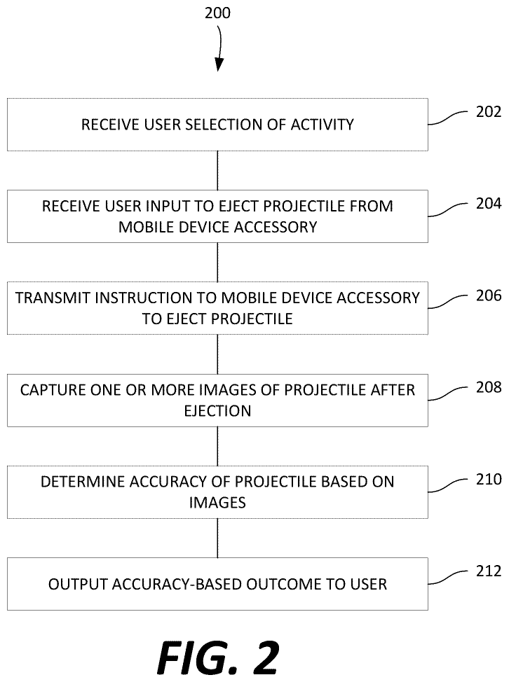

FIG. 2 is a flow chart illustrating an example method 200 of performing a mobile electronic device projectile-based activity with an intelligent phone case. The method 200, or portions thereof, may be performed by a mobile device 102 having a projectile accessory 104 as described herein, in some embodiments. The method 200, or portions thereof, may generally find use in association with activities in which one or more projectiles 106 are ejected from a mobile device accessory 104 attached to or otherwise associated with a mobile device 102 performing the method 200. While FIG. 2 is described with regard to ejecting a projectile, it should be appreciated that the method 200 may additionally or alternatively include similar game interactions such as lasers (e.g., laser tag), water ejection, or the like. The descriptions of scoring or outcomes may be applied to at least these similar types of games.

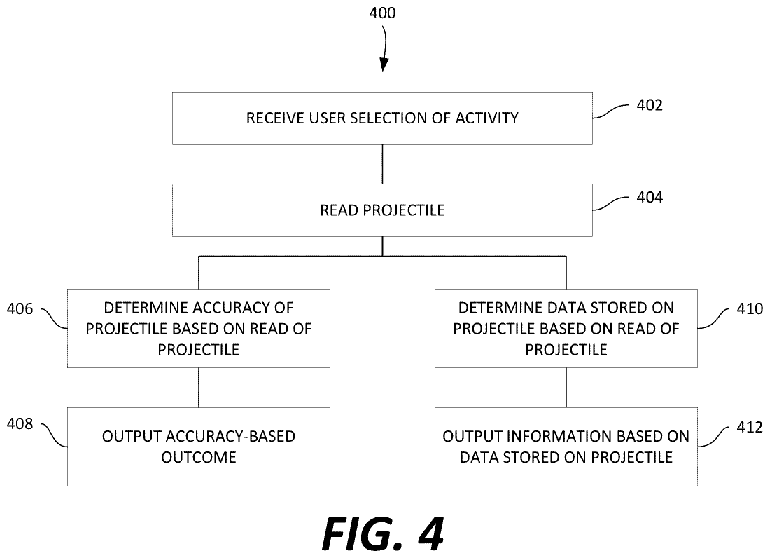

The method may include, at block 202, receiving a user selection of an activity. The user selection may be received from a user interaction with a graphical user interface (GUI) on a display 116 of the mobile computing device 102, in some embodiments. For example, an application executing on the mobile computing device 102 may provide the GUI and the GUI may include a plurality of activities from which the user may select. The activities may include, for example, different activities, such as games, each of which may include one or more aspects of the method 200 and/or one or more aspects of the other methods of this disclosure. Descriptions of example activities are provided hereinbelow after the description associated with FIG. 4. In response to receiving the user selection of an activity, a GUI portion may be provided that includes controls and/or other input and output portions for that activity, as well as a display associated with that activity, on the mobile device 102. In some embodiments, the GUI may be presented as part of an Augmented Reality (AR) or Virtual Reality (VR) environment. In some cases, the AR/VR environment may be presented on the display of the mobile device and/or use a camera or other sensor of the mobile device, and augment the environment based on communication with the intelligent phone case.

With continued reference to FIG. 2, the method 200 may further include, at block 204, receiving a user input to eject a projectile 106 from a mobile device accessory 104. The user input may be received through the GUI, for example, with actuation of a button of the mobile computing device 102, through a predetermined user movement of the mobile computing device 102 (e.g., a shake, tilt, etc. of the mobile computing device, as detected by a gyroscope 118 of the mobile computing device 102, for example), and/or through other input to the mobile computing device 102.

In other embodiments, the user input to eject a projectile 106 may be received directly by the mobile device accessory 104. For example, the user may use a button, trigger, or other input mechanism on the mobile device accessory 104 to provide the input.

The method 200 may further include, at block 206, transmitting an instruction to the mobile device accessory 104 to eject a projectile 106. In some embodiments, the instruction at block 206 may be transmitted in response to receipt of the user input at block 204. The instruction may be transmitted over a communications channel between the mobile computing device 102 and the mobile device accessory 104, in some embodiments.

The method 200 may further include, at block 208, capturing one or more images of the projectile 106 after its ejection from the mobile device accessory 104. The one or more images may be captured by a camera 114 of the mobile computing device 102, in some embodiments. The one or more images may be a video, for example. The one or more images may be captured automatically at a predetermined time after the user input of block 204 or the instruction of block 206, which predetermined time may be set at a time when the projectile 106 is expected to be in the field of view of the camera 114 after ejection.

The method 200 may further include, at block 210, determining an accuracy of the projectile 106 based on one or more images. Determining an accuracy at block 210 may include, for example, determining the closest the projectile came to a predetermined target, in some embodiments. The target may be determined according to the activity selected by the user at block 202, in some embodiments. The target may be, for example, another object, such as a stationary object, another mobile device, another mobile device accessory, a user of another mobile device, and/or a virtual “target” area in space. In some embodiments, the virtual target area in space may be a hologram output by another mobile device 102, for example.

Determining an accuracy may include, in some embodiments, applying one or more object recognition algorithms to one or more of the images to determine an inclusion, position, and classification of the projectile 106, the target, and/or one or more other objects in the one or more images. After determining the positions of the projectile 106 and the target in one or more images, the mobile computing device 102 may determine the closest position of the projectile to the target, in some embodiments. The mobile computing device 102 may determine whether the projectile contacted the target (which “contact” may be passing through the target zone in the case of a virtual target), in some embodiments. The accuracy may be quantified as a closest distance, in some embodiments, and/or as a binary outcome (e.g., hit or did not hit the target).

The method 200 may further include, at block 212, outputting an accuracy-based outcome. The outcome may be or may include, for example, the closest distance between the projectile 106 and the target, a binary outcome of the projectile 106 (e.g., hit or did not hit the target), a ranking of the projectile accuracy relative to one or more other projectiles 106 fired by the user or by a different user, and/or another outcome relevant to the particular activity selected by the user at block 202 and based on the accuracy of the projectile 106 fired by the user. The outcome may be output on the mobile device performing the method 200, in some embodiments. Additionally or alternatively, the outcome may be output by being transmitted to another mobile device 102, such as a mobile device of another user participating in the activity.

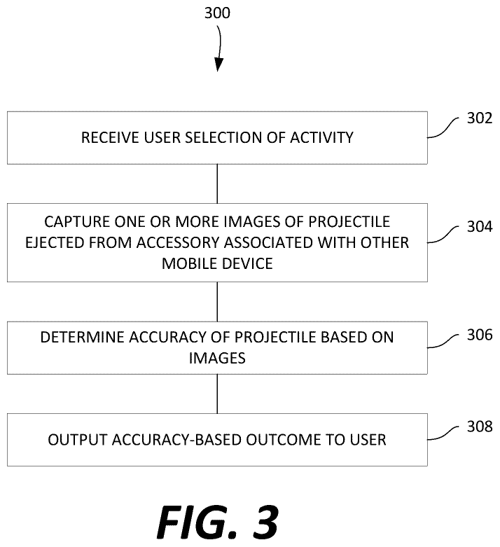

FIG. 3 is a flow chart illustrating an example method 300 of performing a mobile electronic device projectile propulsion activity with an intelligent phone case. The method 300, or portions thereof, may be performed by a mobile device having a projectile accessory as described herein, in some embodiments. The method 300, or portions thereof, may generally find use with activities in which one or more projectiles 106 are ejected by accessories 104 that are not attached to or otherwise associated with the mobile computing device 102 performing the method 300.

The method 300 may include, at block 302, receiving a user selection of an activity. Block 302 may include substantially the same operations as block 202 of the method 200 of FIG. 2.

The method 300 may further include, at block 304, capturing one or more images of a projectile ejected from an accessory 104 associated with another mobile device 102. The one or more images may be captured by a camera 114 of the mobile computing device 102, in some embodiments. The one or more images may be a video, for example. The images may be captured in response to the activity selection from the user in block 302, in some embodiments. In other embodiments, the images may be captured responsive to other input from the user, such as user selection of an image capture mode through the GUI as part of the activity selected by the user.

The method 300 may further include, at block 306, determining an accuracy of a projectile 106 based on the one or more images, such as a projectile fired by another accessory 104. Determining an accuracy at block 306 may be substantially the same as determining an accuracy at block 210, except in embodiments in which the mobile computing device 102 executing block 306 is itself the target. In such embodiments, determining an accuracy at block 306 may include determining the closest distance of the projectile 106 to the mobile computing device 102 itself (e.g., according to one or more object recognition and other algorithms).

The method 300 may further include, at block 308, outputting an accuracy-based outcome. Block 308 may include substantially the same operations as block 212 of the method 200 of FIG. 2.

FIG. 4 is a flow chart illustrating an example method 400 of performing a mobile electronic device projectile propulsion activity with an intelligent phone case. The method 400, or portions thereof, may be performed by a mobile device 102 having a projectile accessory 104 as described herein, in some embodiments. The method 400, or portions thereof, may generally find use with activities in which one or more projectiles 106 are ejected by accessories 104 that are not attached to or otherwise associated with the mobile computing device 102 performing the method.

The method 400 may include, at block 402, receiving a user selection of an activity. Block 402 may include substantially the same operations as block 202 of the method 200 of FIG. 2.

The method 400 may further include, at block 404, reading a projectile 106, which may include reading a computer-readable memory 132 on or in the projectile 106, such as an RFID chip, a memory associated with an NFC transmitter/receiver, or some other short-range memory read, in some embodiments. The projectile 106 that is read at block 404 may have been ejected from a mobile computing device accessory 104 attached to or otherwise associated with the mobile device 102 performing block 404, or may have been ejected from a mobile computing device accessory 104 attached to or otherwise associated with a mobile device 102 that is different from the one performing block 404.

The projectile memory 132 may be read at block 404 for one or both of two different purposes: determining an accuracy of the projectile 106 (e.g., by determining whether or not the projectile is close enough to the mobile device 102 for the mobile device to read the projectile 106), and/or obtaining data stored on the projectile 106.

When the projectile 106 is read to determine an accuracy of the projectile, the method 400 may include, at block 406, determining an accuracy of the projectile 106 based on the read of the projectile 106 at block 404. Determining an accuracy of the projectile 106 at block 406 may include, for example, making a binary decision about whether or not the projectile 106 was able to be read, from which it may be concluded that the projectile 106 was within a known read distance of the mobile computing device 102 performing block 406 (or was not). In another embodiment, determining an accuracy of the projectile at block 406 may include measuring a communications channel strength between the projectile 106 and the mobile computing device 102 performing block 406 (which may include, for example, measuring the field strength of a magnetic field, such as for NFC communications, emitted by the projectile 106) and determining an accuracy according to that field strength.

The method 400 may further include, at block 408, outputting an accuracy-based outcome. Block 408 may include substantially the same operations as block 212 of the method 200 of FIG. 2.

As noted above, in addition to or instead of reading the projectile 106 to assess its accuracy, the projectile 106 may be read to obtain data stored on the projectile 106. Accordingly, the method 400 may further include, at block 410, determining data stored on the projectile 106 based on the read of the projectile 106 and, at block 412, outputting information based on the data stored on the projectile 106. Outputting information at block 412 may include, in some embodiments, outputting the data stored on the projectile 106. Additionally or alternatively, outputting information at block 412 may include retrieving or otherwise determining information stored on the mobile computing device 102 based on the data read from the projectile 106 (e.g., via lookup table) and outputting the stored information.

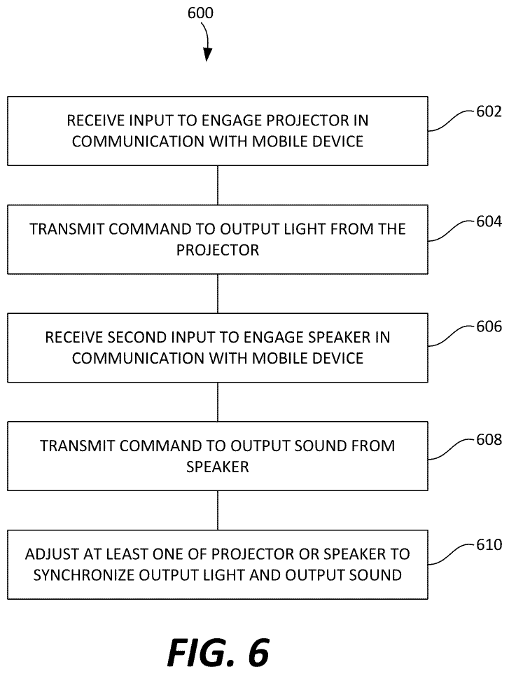

FIG. 6 is a flow chart illustrating an example method 600 of coordinating mobile device activities using accessories. The method 600, or portions thereof, may be performed by a mobile device 102 as described herein, in some embodiments. The method 600, or portions thereof, may generally find use with activities in which one or more accessories 104 associated with respective mobile computing devices 102 are coordinating outputs.

The method 600 may include, at block 602, receiving an input to engage the projector (e.g., projector 144) of an accessory (e.g., accessory 104) in communication with a mobile device (e.g., mobile device 102). The input may be received by a screen of the mobile device 102 physically coupled with the accessory 104, or by a screen of a mobile device in communication with but not physically coupled with the accessory 104. For example, the mobile device 102 may be uncoupled from the accessory 104 when the input is received, or the mobile device 102 may receive the input for a different accessory than the one to which the device 102 is coupled (e.g., a different device's accessory 104).

The method 600 may further include, at block 604, transmitting a command to output light from the projector 144. The command may be transmitted from a processor 138 of the accessory 104 based on the input received at block 602.

The method 600 may further include, at block 606, receiving a second input to engage a speaker (e.g., speaker 146) in communication with the mobile device 102. The second input, light the first input, may be received by a screen of the mobile device 102 physically coupled with the accessory 104, or by a screen of a mobile device in communication with but not physically coupled with the accessory 104. In some examples, the first and second inputs may be received from the same mobile device 102, while in other examples, the first and second inputs may be received from different mobile devices.

The method 600 may further include, at block 608, transmitting a command to output sound from the speaker. The command may be transmitted from a processor 138 of the accessory 104 based on the input received at block 602.

The method 600 may further include, at block 610, adjusting at least one of the projector or the speaker to synchronize the output light and the output sound. This adjustment may include the introduction of a pause or other break in order to bring an output that is ahead in-time of the other to be in-line with the other. For example, if the output light is a projected video and the output sound is the audio for the projected video, and the audio is ahead of the video (e.g., video de-sync), the adjustment may be to pause the output sound for an amount of time equal to the amount the audio is ahead. In another example, adjusting the output light may include selecting a pattern of lights that would go along with the output sound. For example, the output sound may be a song, and the previously output light may be a pattern of colors and durations that may not go with (e.g., contradict) the output song, such as if the output light pattern is a different tempo or different mood than the output song. In this example, the adjustment may be to change the output light pattern to a more suitable pattern (e.g., matching tempo, etc.).

The methods 200, 300, 400, 600 of FIGS. 2-4 and 6, or respective portions thereof, may be executed separately or together by one or more mobile computing devices 102 to perform one or more activities involving one or more accessories 104 respectively associated with those mobile computing devices 102. Example activities are described below.

Example Activity—Truth or Dare. Two users encode a truth or dare message into respective readable projectiles 106 (e.g., which encoding may be performed by the accessory). Both users' mobile computing devices serve as the target for the other user to aim for with their projectile, and serve as the display for the user. The users shoot projectiles at each others' mobile devices 102. Projectile tracking and activity software stored on the mobile computing devices 102 measure both shots and determine that one user's shot was a better shot because it landed closer to the target. The second user, with the worse shot, must select a truth or dare contained in the projectile memory 132 that was propelled by the first user's accessory 104. The second user reads the first user's projectile 106 with the second user's mobile computing device 102 and performs the encoded truth or dare.

Example Activity—Baseball. A first user's mobile device accessory 104 shoots/propels a projectile 106 which contains readable messages just like a pitcher propels a baseball. A second user uses a small object, such as a pen, as a bat and may point the camera 114 of their mobile device 102 towards the first user's mobile device accessory 104. The second user's mobile device 102 defines a strike zone, which may be communicated to the first user's mobile device 102 and superimposed on the first and second user's displays 116. The first user shoots a projectile 106 at the second user's strike zone. The first and/or second users' mobile devices 102 may capture one or more images of the projectile 106 in flight and determine whether the “pitch” was a ball or strike, i.e., whether or not the “pitch” hit the strike zone. If the second user hits the projectile 106 with the pen (being used as a bat) then the second user can read the projectile 106 with their mobile device 102 and require the first user to perform an action stored as data on the pitched projectile 106. The batter may continue to bat until the batter strikes out on a predetermined number of projectiles 106. Then, batter and pitcher may switch.

Example Activity—HORSE. Just like in basketball, one user creates shots that another user must duplicate. “I will bank a projectile off the 3r d locker to the end of the hall on the right side of the hall but it must land heads side up.” Every time one user wins a round, that user draws at random one of the other user's projectiles 106 and keeps it.

Example Activity—Zodiac. Twelve (12) different projectiles 106 may be provided and distributed among users, with each projectile displaying a different zodiac symbol. Each user attempts to land their projectile 106 on a target surface or target area on a surface. If a user's zodiac projectile 106 successfully lands on the target surface or area, then that user may read the projectile 106 with their mobile device 102, and the projectile data may link to a horoscope from a website that is based on the user's birthdate, gender, age, etc.

Example Activity—My Song/Your Song. Multiple mobile devices 102 from multiple users are synced to make a stereo effect. The users 102 have a contest of shooting projectiles 106 (like closest to the pin in golf). The user that wins the contest is permitted to pick the next song that will play over the speakers of all mobile devices 102 and accessories 104.

Example Activity—Supplement to Combat Game. The user plays a mobile simulated combat game as the user normally would on their mobile device 102, but the game is supplemented with a shooting contest with projectiles 106. The user that wins the contest receives an advantage in the game (e.g., the winning user gains troops, the losing user loses troops, etc.) The shooting contest with projectiles 106 may include one or more projected images, video, and/or light fields from accessories 104 as targets for the projectiles 104.

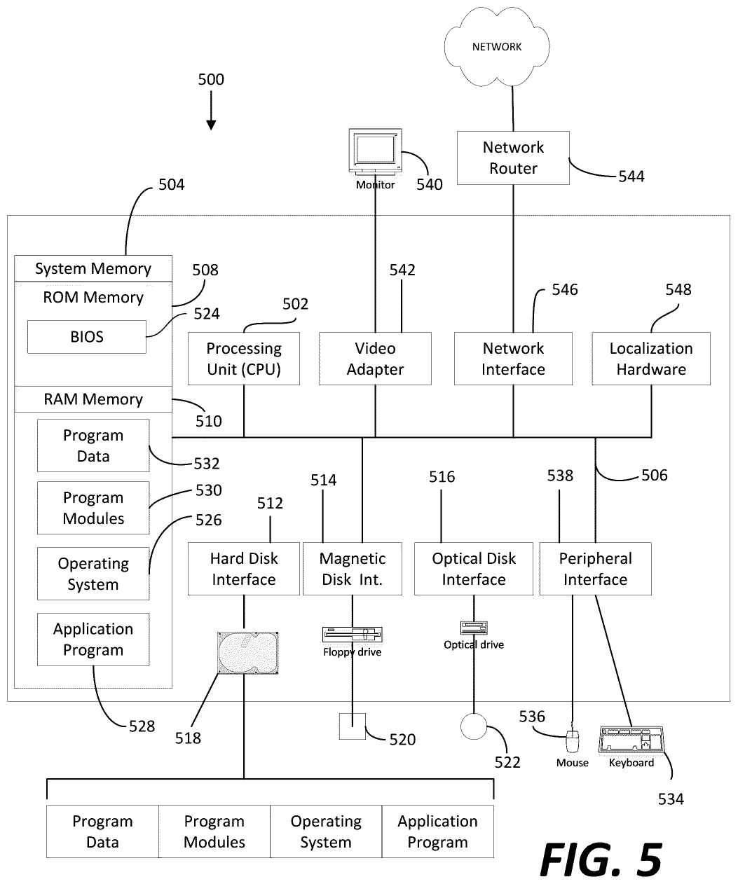

FIG. 5 is a diagrammatic view of an example embodiment of a user computing environment that includes a general purpose computing system environment 500, such as a desktop computer, laptop, smartphone, tablet, or any other such device having the ability to execute instructions, such as those stored within a non-transient, computer-readable medium. Furthermore, while described and illustrated in the context of a single computing system 500, those skilled in the art will also appreciate that the various tasks described hereinafter may be practiced in a distributed environment having multiple computing systems 500 linked via a local or wide-area network in which the executable instructions may be associated with and/or executed by one or more of multiple computing systems 500.

In its most basic configuration, computing system environment 500 typically includes at least one processing unit 502 and at least one memory 504, which may be linked via a bus 506. Depending on the exact configuration and type of computing system environment, memory 504 may be volatile (such as RAM 510), non-volatile (such as ROM 508, flash memory, etc.) or some combination of the two. Computing system environment 500 may have additional features and/or functionality. For example, computing system environment 500 may also include additional storage (removable and/or non-removable) including, but not limited to, magnetic or optical disks, tape drives and/or flash drives. Such additional memory devices may be made accessible to the computing system environment 500 by means of, for example, a hard disk drive interface 512, a magnetic disk drive interface 514, and/or an optical disk drive interface 516. As will be understood, these devices, which would be linked to the system bus 506, respectively, allow for reading from and writing to a hard disk 518, reading from or writing to a removable magnetic disk 520, and/or for reading from or writing to a removable optical disk 522, such as a CD/DVD ROM or other optical media. The drive interfaces and their associated computer-readable media allow for the nonvolatile storage of computer readable instructions, data structures, program modules and other data for the computing system environment 500. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 500.

A number of program modules may be stored in one or more of the memory/media devices. For example, a basic input/output system (BIOS) 524, containing the basic routines that help to transfer information between elements within the computing system environment 500, such as during start-up, may be stored in ROM 508. Similarly, RAM 510, hard drive 518, and/or peripheral memory devices may be used to store computer executable instructions comprising an operating system 526, one or more applications programs 528 (such as the modules 134, 136 of FIG. 1, or a browser or application for accessing a digital social media network), other program modules 530, and/or program data 532. Still further, computer-executable instructions may be downloaded to the computing environment 500 as needed, for example, via a network connection.

An end-user, e.g., an end user of a social network or a third-party content provider, may enter commands and information into the computing system environment 500 through input devices such as a keyboard 534 and/or a pointing device 536. While not illustrated, other input devices may include a microphone, a joystick, a game pad, a scanner, etc. For example, the accessory 104 may include a game pad for use with a game played on the mobile device 102, and may serve as a game controller even when not mechanically coupled to the mobile device 102. These and other input devices would typically be connected to the processing unit 502 by means of a peripheral interface 538 which, in turn, would be coupled to bus 506. Input devices may be directly or indirectly connected to processor 502 via interfaces such as, for example, a parallel port, game port, firewire, or a universal serial bus (USB). To view information from the computing system environment 500, a monitor 540 or other type of display device may also be connected to bus 506 via an interface, such as via video adapter 542. In addition to the monitor 540, the computing system environment 500 may also include other peripheral output devices, not shown, such as speakers and printers.

The computing system environment 500 may also utilize logical connections to one or more computing system environments. Communications between the computing system environment 500 and the remote computing system environment may be exchanged via a further processing device, such a network router 544, that is responsible for network routing. Communications with the network router 544 may be performed via a network interface component 546. Thus, within such a networked environment, e.g., the Internet, World Wide Web, LAN, or other like type of wired or wireless network, it will be appreciated that program modules depicted relative to the computing system environment 500, or portions thereof, may be stored in the memory storage device(s) of the computing system environment 500.

The computing system environment 500 may also include localization hardware 548 for determining a location of the computing system environment 500. In embodiments, the localization hardware 548 may include, for example only, a GPS antenna, an RFID chip or reader, a WiFi antenna, or other computing hardware that may be used to capture or transmit signals that may be used to determine the location of the computing system environment 500.

The computing environment 500, or portions thereof, may comprise one or more components of the system 100 of FIG. 1, in embodiments, such as the mobile device 102, the accessory 104, and/or the projectile 106.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. An accessory for a mobile computing device, the accessory comprising:
a body defining an interior configured to secure a mobile computing device;
an accessory mechanism coupled to the body and configured to perform at least one supporting action for the mobile computing device; and
a communications module configured to receive an electronic command to engage the accessory mechanism.

2. The accessory of claim 1, wherein the accessory mechanism comprises a movement mechanism configured to effect movement of the accessory.

3. The accessory of claim 2, wherein the movement mechanism comprises a vibration element.

4. The accessory of claim 2, wherein:
the movement mechanism comprises:
a motor, and
at least one wheel in mechanical communication with the motor, and
the electronic command engages the motor.

5. The accessory of claim 2, wherein:
the movement mechanism comprises:
a motor, and
a mid-air propulsion device in mechanical communication with the motor, and
the electronic command engages the motor.

6. The accessory of claim 1, wherein the accessory mechanism comprises a projector configured to output an image displayed on the mobile computing device.

7. The accessory of claim 1, wherein the accessory mechanism comprises a projector configured to output a projected image based on but different from an image displayed on the mobile computing device.

8. The accessory of claim 1, wherein:
the accessory mechanism comprises a projector and a speaker,
the speaker is configured to output sounds from the mobile computing device, and
the projector is configured to output lights in coordination with the output sounds.

9. The accessory of claim 1, wherein:
the accessory mechanism comprises a game pad for use with the mobile computing device, and
the communication module is further configured to receive, from the game pad, a second electronic command to control the mobile computing device.

10. The accessory of claim 9, wherein the game pad remains in communication with the mobile computing device via the communication module after the mobile computing device is mechanically decoupled from the body.

11. A system comprising:
a body defining an interior configured to secure a mobile computing device;
an accessory mechanism coupled to the body and configured to perform at least one supporting action for the mobile computing device;
a movement mechanism configured to effect movement of the body; and
a communications module configured to receive an electronic command to engage the accessory mechanism.

12. The system of claim 11, wherein the movement mechanism comprises a vibration element.

13. The system of claim 11, wherein:
the movement mechanism comprises:
a motor, and
at least one wheel in mechanical communication with the motor, and
the electronic command engages the motor.

14. The system of claim 11, wherein:
the movement mechanism comprises:
a motor, and
a mid-air propulsion device in mechanical communication with the motor, and
the electronic command engages the motor.

15. The system of claim 11, wherein:
the accessory mechanism comprises a projector and a speaker,
the speaker is configured to output sounds from the mobile computing device, and
the projector is configured to output lights in coordination with the output sounds.

16. The system of claim 11, wherein:
the accessory mechanism comprises a game pad for use with the mobile computing device, and
the communication module is further configured to receive, from the game pad, a second electronic command to control the mobile computing device.

17. The system of claim 11, further comprising:
a processor; and
a non-transitory, computer-readable memory storing instructions that, when executed by the processor, cause the accessory to:
engage the accessory mechanism.

18. A method comprising:
receiving, from a user by a mobile computing device, an input to engage a projector in communication with the mobile computing device;
transmitting, by the mobile computing device to the projector, a command to output light from the projector;
receiving, from the user by the mobile computing device, a second input to engage a speaker in communication with the mobile computing device;
transmitting, by the mobile computing device to the speaker, a command to output sound from the speaker; and
adjusting, by the mobile computing device, at least one of the projector or the speaker to synchronize the output light and the output sound.

19. The method of claim 19, wherein each of the mobile computing device, the projector, and the speaker is housed in an accessory.

20. The method of claim 20, further comprising:
establishing a connection with a second mobile computing device; and
synchronizing an output from the second mobile computing device with the output light and the output sound.
